(19) United States
(12) Patent Application Publication
(10) Pub. No.: US 2025/0182237 A1
(43) Pub. Date: Jun. 5, 2025

(54) Layout for Projected Displays

(71) Applicant: Samsung Electronics Co., Ltd., Suwon-si (KR)

(72) Inventors: Minxun Zheng, Santa Clara, CA (US); Brian Harms, San Jose, CA (US); Polina Timchenko, Los Angeles, CA (US); Mykhailo Babak, San Jose, CA (US)

(21) Appl. No.: 18/527,325

(22) Filed: Dec. 3, 2023

(51) Int. Cl. H04N 9/31; G06T 3/00; G06V 20/50

(52) U.S. Cl. CPC G06T 3/10; G06V 20/50

(57) ABSTRACT

In one embodiment, a method includes accessing an image of a scene that includes a display device and at least a portion of an environment of the display device, where the portion of the environment includes a surface in the vicinity of the display device. The method further includes determining, based on the portion of the environment of the display device, a region of the surface that is available to project one or more content items onto; and projecting, by a projector, the one or more content items onto at least a portion of the determined region of the surface that is available to project one or more content items onto.

### TECHNICAL FIELD

This disclosure generally relates to projected displays.

### BACKGROUND

Electronic display screens are often used to view content. For example, a TV is typically wall mounted or set on a piece of furniture, and the TV includes a screen that displays content selected by a user viewing the content. The content is typically delivered via over-the-air connection (e.g., using an antenna), a wired connection (e.g., a coaxial, optical fiber, or HDMI cable), or a wireless connection (e.g., using a Wi-Fi receiver to stream content).

A display typically shows only one source of content (e.g., one program or video) at a time. A display device that is capable of simultaneously receiving, processing, and displaying multiple sources of content can show content from multiple sources by dividing the available display-screen area among the sources of content. For example, a TV that has picture-in-picture capabilities can show a first program on a first portion of the TV screen and a second program on a second portion of the TV screen. However, this often reduces the viewing quality (size, resolution, etc.) of each content.

### BRIEF DESCRIPTION OF THE DRAWINGS

FIG. 1 illustrates an example method for determining how and where to project content on a surface near a display screen.

FIG. 2 illustrates an example physical setup.

FIG. 3 illustrates example images showing aspects of the example method of FIG. 1.

FIG. 4 illustrates an example process for implementing aspects of the example method of FIG. 1.

FIG. 5 illustrates example images of a scene that includes a wall surface and multiple objects occluding portions of the surface.

FIG. 6 illustrates an example scoring approach that adopts a beam search.

FIG. 7 illustrates visual aspects of two different environments.

FIG. 8 illustrates an example computing system.

### DESCRIPTION OF EXAMPLE EMBODIMENTS

Embodiments of this disclosure relate to projecting one or more content items on a surface. The content items may be projected in connection with, and may be based on, content displayed on a display screen, such as a TV screen. In contrast to picture-in-picture approaches, which force users to reduce viewing quality in order to view multiple content items, embodiments of this disclosure make use of available non-screen surfaces near a display screen, thereby allowing users to view multiple content items without suffering reductions in viewing quality. As explained more fully herein, embodiments of this disclosure identify a usable projection area surrounding a user's displays, determine the best locations for specific content within the usable projection area, determine the most appropriate content to display for a user based on their preferences, and detect the optimal position of a projector for the projected user content (e.g., by giving a user feedback on how to move the projector to avoid a skewed image or to avoid objects).

Projectors are often smaller, lighter, and more flexible (e.g., more mobile) than TV screens, making them ideal for use in a variety of environments. When projecting onto an imperfect surface (e.g., a crowded wall with pictures, mirrors, and shelves), users may need to spend a significant amount of time adjusting the projection site, for example so that projected content doesn't overlap with objects on a wall. Additionally, users may have to re-setup the projector whenever using it in a new environment, which can be frustrating. Any particular projection site is often very different from other projection sites (e.g., different objects are present, in different sizes and locations), and optimizing a projection site can be a time-consuming and difficult process, and may require manually reorganizing the projection site (e.g., moving or removing pictures or shelving, etc.)

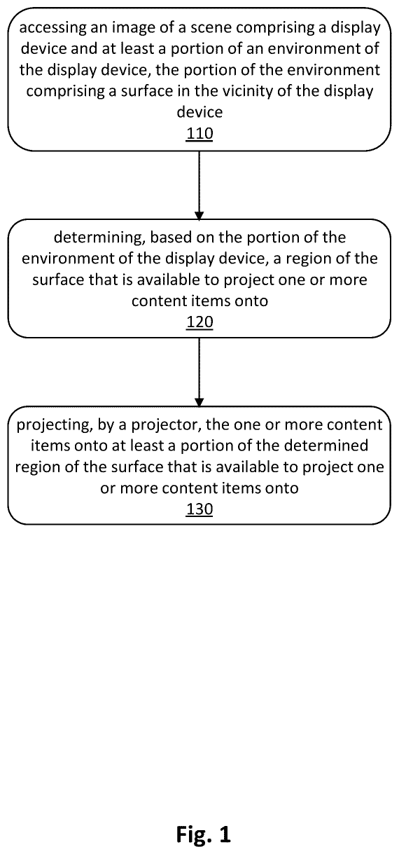

FIG. 1 illustrates an example method for determining how and where to project content onto a surface near a display screen. While the example method of FIG. 1 relates to projecting content near a display screen, the techniques described herein may be used to determine how and where to project content on any surface, whether or not a display screen is present.

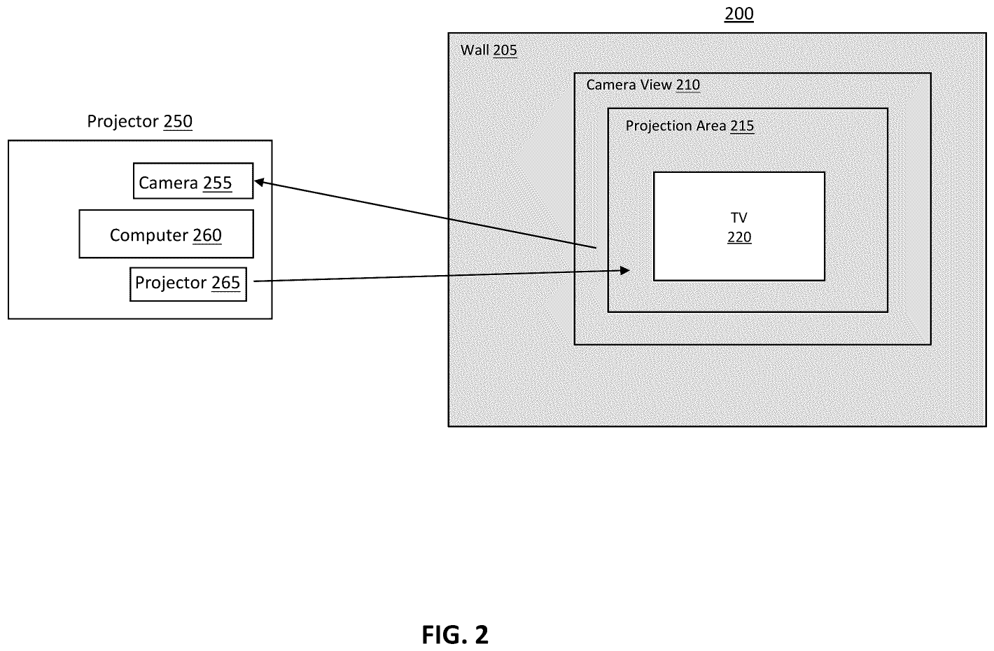

Step 110 of the example method of FIG. 1 includes accessing an image of a scene that includes a display device and at least a portion of an environment of the display device. The portion of the environment includes a surface (e.g., a surface of a wall) in the vicinity of the display device. As explained below, the environment may also include one or more objects on the surface (e.g., a picture hanging on the wall) or in front of the surface (e.g., a table or a vase in front of a wall, etc.). The display device may be a TV, but this disclosure contemplates any suitable display, such as an electronic picture frame, a computer monitor, a tablet or laptop screen, etc. FIG. 2, which illustrates an example physical setup of certain embodiments of this disclosure, illustrates a scene 200 that includes wall 205, a maximum projection area 210 that can be obtained by projector 250, and a TV 215. As illustrated in FIG. 2 and explained below, a camera view 210 captures an image of part of the scene 200.

In particular embodiments, accessing an image of the scene can include capturing an image of the scene. The image may be captured by a camera that is part of a projector. For instance, in the example of FIG. 2, projector 250 includes a camera 255. Camera 255 may take an image of a scene, either on demand or automatically (e.g., at the start of performing the example method of FIG. 1). In particular embodiments, an accessed image in step 110 of the example method of FIG. 1 may be captured by a camera from another device, such as a camera on a smartphone or laptop or by a stand-alone camera. The captured image may be sent to a projector, or may be stored by a device (e.g., a smartphone, a server, a personal computer, etc.), and the image may be accessed from that device. More generally, some or all of step 110 and/or step 120 of the example method of FIG. 1 may be performed by a projector, by another device, or by a combination of devices. For instance, in the example of FIG. 2, projector 250 may include a computer 260, which can access an image captured by a camera (e.g., camera 255) and can perform some or all of the processing steps described herein. In other embodiments, a projector may or may not include such processing capabilities, and some or all of the processing may occur on another computing device, with the processing results then sent to the projector.

Step 120 of the example method of FIG. 1 includes determining, based on the portion of the environment of the display device, a region of the surface that is available to project one or more content items onto. In particular embodiments, step 120 may include determining a maximum projection area 215 that content can be projected onto. As described more fully below, in particular embodiments step 120 may include determining whether objects or other visual elements (e.g., strong colors, brightly-lit portions of the surface, etc.) render a portion of the projection area unsuitable or undesirable for projecting an image onto.

In particular embodiments, an image may be skewed relative to a display device and a surface near the display device. For instance, the center of a camera's field of view may not be parallel to the surface normal, resulting in a slant between the image's perspective and the surface. A skewed image can result in a skewed projection from a projector, and therefore particular embodiments may deskew an accessed image. For example, geometric features in the scene (as captured by the image or by another image) may be used to deskew the image. For example, at least a portion of an object such as a picture frame or the edges of the display screen (e.g., a corner of the display screen) may be detected in an image (e.g., using objection-recognition techniques). The geometric shape of the detected object may be compared to a rectangular shape, and the image may be deskewed (i.e., transformed) so that the detected object's shape in the deskewed image is rectangular. As another example, an image may displayed on the display screen (e.g., a predetermined geometric shape such as a circle, a square, etc.) and the accessed image may be deskewed so that the displayed image on the display screen is unskewed (e.g., a displayed circle appears as a circle rather than as an ellipse, etc.). The transformation to deskew an image can then be used to generate an image that represents the scene as if the camera was perpendicular to the scene. As a result, a camera (e.g., camera 255 in projector 250) need not be oriented perpendicular to a scene in order to capture a usable image of the scene, improving the placement options of the camera and/or the projector.

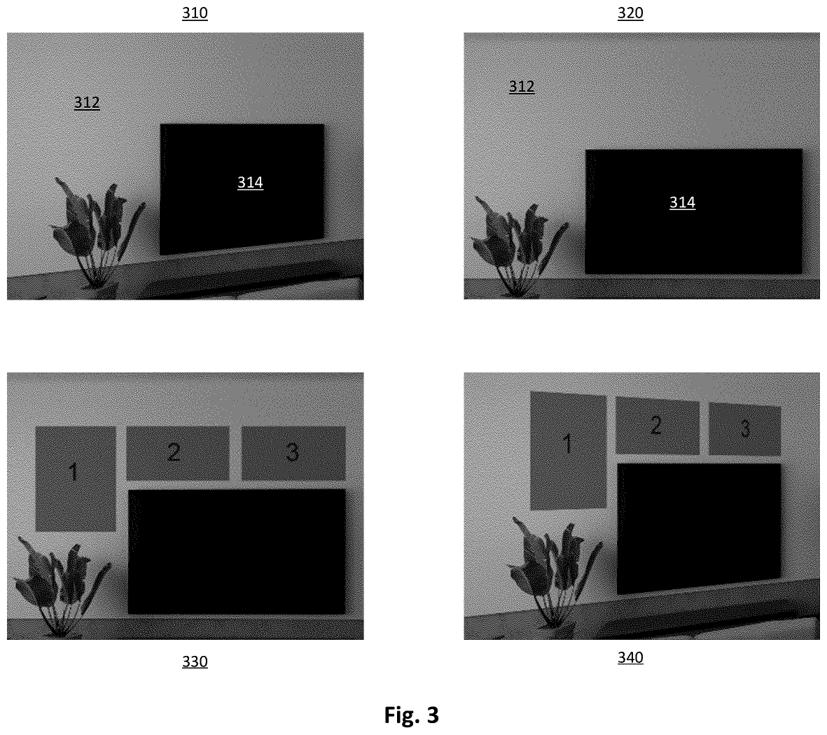

FIG. 3 illustrates example images of aspects of the example method of FIG. 1. Image 310 in the example of FIG. 3 illustrates an original photo capture by a camera that has a skewed perspective relative to wall 312 and TV 314. Image 320 illustrates a deskewed image, i.e., image 310 transformed so that it is deskewed relative to wall 312 and TV 314.

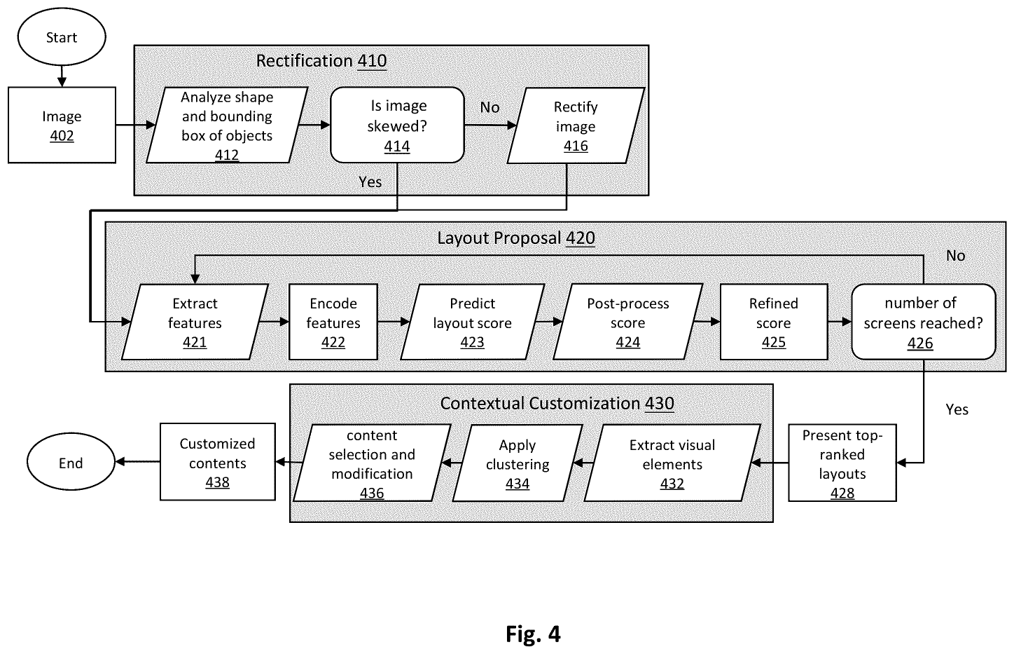

FIG. 4 illustrates an example process for implementing aspects of the example method of FIG. 1, among other things. The process of FIG. 4 begins with step 402 by accessing an image of a projection surface. The process includes a rectification procedure 410. In the rectification procedure, step 412 includes analyzing the shape and bounding box (e.g., the shape as defined by the edges of a detected object) of objects captured in the image. In particular embodiments, an image's skew may be determined based on a bounding box identified for an object in an image, rather than based on the object itself. Using the result of step 412, step 414 determines whether the camera is perpendicular to the captured scene. If not, then the image is rectified in step 416. Otherwise, if the image is not skewed, then the process of FIG. 4 can proceed to determining where and how projection should occur.

In particular embodiments, step 120 of the example method of FIG. 1 can include determining portions of the surface captured in the image that are not suitable for projection. In particular embodiments, step 120 of the example method of FIG. 1 can include determining the attributes of each potential projection area, such as the size and shape of each projection area. In particular embodiments, step 120 of the example method of FIG. 1 can include determining which layout of multiple potential layouts is the optimal layout (e.g., of multiple possible combinations of sizes and shapes for content to projection in a projection area, which particular combination is best). As explained below, the optimal layout may depend on factors such as the number of projection sites, user preferences, and/or the content to be displayed in a projected area. In particular embodiments, determining suitable projection areas and optimal layouts may be combined, such as in the layout proposal process 420 of FIG. 4. In particular embodiments, these procedures may be performed separately (e.g., sequentially).

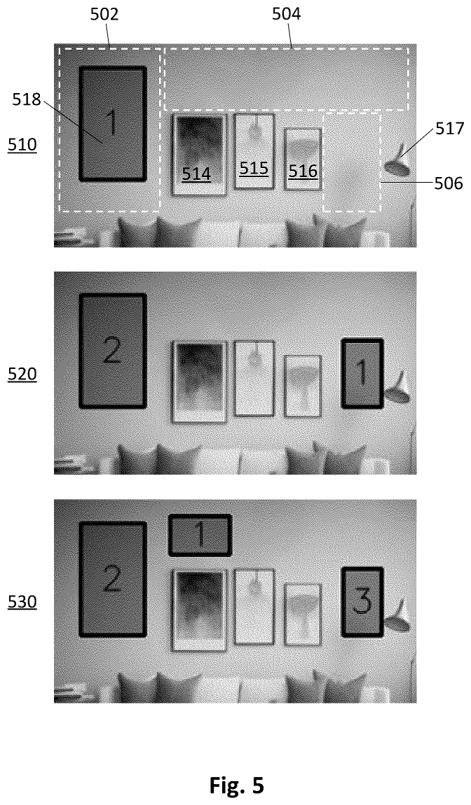

In particular embodiments, determining portions of the surface captured in the image that are not suitable for projection includes determining an exclusion area of the surface that is not suitable for projection. For example, the exclusion area may include one or more objects on the surface or occluding the surface, one or more colors or textures that are unsuitable for projection onto, or a brightly-lit area that would make the projection difficult to discern. For example, using the image accessed in step 110, objects may be identified in the maximum projection area of the image. The areas occupied or occluded by these objects are excluded from the potential projection area. FIG. 5 illustrates example images of a scene that includes a wall surface and multiple objects occluding portions of the surface. Images 510, 520, and 530 illustrate picture frames 514, 515, and 516 hanging on wall 512 and lamp 517 obscuring a portion of wall 512. These objects may be determined by an object-recognition algorithm, taking the accessed image as the input. These areas are not suitable for projecting onto and therefore are excluded from the potential projection area, leaving the remaining portion of the wall available for projection.

Images 510, 520, and 530 illustrate different potential layouts for the resulting projection based on the number of displays to project. Image 510 illustrates a single projected display 518 for a first content. Image 520 illustrates two projected displays: projection 522 for a first content and projection 524 for a second content. Image 530 illustrates three projected displays. In each instance, the projected displays are sized and placed on the region of wall 512 that is not part of the exclusion area, as determined by the detected objects that obscure the surface. In addition, if portions of wall 512 were deeply colored (e.g., a deep red color) or strongly textured (e.g., a stucco wall), then those portions may be excluded from the possible projection area, for example if other areas do not contain those strong visual elements.

FIG. 5 illustrates an example in which a projector projects one or more displays without the presence of a display screen (e.g., a TV). As illustrated in this example, the steps of accessing an image, determining an available projection area, and projecting content onto at least a part of the available projection area are still used when no display screen is present in the image.

In particular embodiments, once an available projection area is determined, the available projection area may be divided into potential projection regions. Each region may be of a particular shape. For example, the available projection area may be divided into the largest contiguous rectangular regions that make up the available projection area. For example, image 510 of FIG. 5 illustrates rectangular regions 502, 504, and 506, which in this example are the largest rectangular regions available for projecting content onto. In particular embodiments, the rectangular regions may overlap. The potential projection regions are not necessarily the size or shape of any final projected display, but instead further define and refine the available projection region.

The available content to project may be determined by a user or automatically, e.g., based on user preferences. In particular embodiments, the available content to project may be based on the content displayed on a display screen, e.g., a TV. For example, a program such as a sporting event may have associated available projection content that includes information about the participants (e.g., a roster list or a currently playing list, statistical information, etc., which may focus on select participants that are most relevant to a user), social media posts about the event, current standings, related maps (e.g., a map of a race course or a golf course), and so on. As another example, gaming content may have associated available content that includes a map of the current level, scores or other statistical information, videos such as walkthroughs or views from the perspective of other participants, etc. As another example, exercise or fitness content may have associated available projection content that includes health-related information such as user vitals (e.g., heart rate, breathing, etc), statistics regarding the workout and/or the user's workout goals, a current soundtrack, etc. As another example, displayed content related to smart devices (e.g., displayed content from a video camera) may have associated available projection content that includes feeds from other cameras (e.g., other security cameras), information from smart devices such as a thermostat, etc. This disclosure, however, is not limited to the specific examples of displayed and projected content described above.

In particular embodiments, the available content may be determined by searching the internet or data on one or more connected devices for content related to the content displayed on the display. The content displayed on the display may be determined based on metadata regarding the content (e.g., metadata accompanying a streamed program) or based on content recognition (e.g., based on detecting text or images in the content). Potential projected content may be provided by one or more applications or third parties. In particular embodiments, a user may specify content available for projection, and that specification may be associated with particular programs or types of programs.

In particular embodiments, a user may select which particular content they would like projected in any particular instance. For example, potential content may be determined for a particular content displayed on a TV, and that potential content may be identified to a user (e.g., in a list, etc.). The user may then select which particular content they would like projected. In particular embodiments, a user may select particular content for projection based on a type of content. For example, a user may specify that video games should include certain types of projected content (e.g., a map of the level, etc.), while other types of content (e.g., statistics) should be projected when watching a sporting event. In particular embodiments, a user may specify types of content to project when the display screen is off (e.g., project an image of pictures, a clock, a calendar, the weather, etc.). In particular embodiments, a user may specify types of content to project based on a time of day and/or on the identity of the user.

In particular embodiments, a user may specify a priority for content available for projection. The priority may be used to determine which content to project, if the available projection area is not sufficiently large to accommodate all selected projections. In particular embodiments, a user may specify preferred aspect ratios, sizes, resolutions, and/or other display aspects, both for projected content generally and for particular types or instances of projected content. For example, for a racing event, a user may specify that the current driver standings may be a first priority, while a track map may be a second priority. As explained below, a priority may be used to determine how and whether to project content to a user (e.g., where the content should be projected, at which size the content should be projected, whether the content should be projected at all, etc.). In particular embodiments, certain video settings such as aspect ratio or resolution may be limited by or specified by the content source. In particular embodiments, a user's content preferences may be determined from the user's historical choices regarding content preferences.

In particular embodiments, step 120 of the example method of FIG. 1 includes ranking a number of potential layouts (e.g., potential locations, sizes, shapes, etc.) for projected content. For example, heuristic rules or a machine-learning model, or both, may be used to evaluate a prospective layout and assign that layout a score. The highest-ranking layout may then be selected, or a number of highest-ranking layouts may be presented to the user (e.g., on the projection area, on a connected device such as a smartphone, etc.), allowing the user to select the layout to use.

In particular embodiments, a machine-learning model may use a deep-learning model that includes an encoder and a layout score predictor. The encoder may be a convolutional neural network that extracts features from the image. The extracted features may be represented by a 3-dimensional tensor. The layout score predictor may be a light-weight neural network. The inputs of the score predictor include the candidate layout (i.e., each projection site's position, aspect ratio, and size) and the accessed image of the projection environment. The output from the deep-learning model is the corresponding score for each layout. In particular embodiments, a set of one or more heuristic rules may be used as post-processing to refine the layout scores provided by the deep-learning model. For example, one heuristic rule may be that the score assigned to a layout is set to negative if the proposed projection site overlaps with detected objects (e.g., pictures on the wall).

FIG. 4 illustrates an example layout proposal process 420. Step 421 includes extracting features from an accessed image. Step 421 may be performed by, for example, any suitable computer-vision algorithm. Step 422 includes encoding the features, for example by using a three-dimensional tensor.

Step 424 includes predicting a layout score for a candidate layout. In particular embodiments, step 424 is performed by a trained neural network. For example, the neural network may be trained on labelled ground-truth data that includes encoded image features, a particular layout, and a corresponding ground-truth score. A candidate layout may consist of the number of projected displays (which may be determined based on the user's preferences or selections), the size of each display, the location of each display, and an aspect ratio of each display. Different candidate layouts may have different parameters for the size, location, and/or aspect ratio of one or more of the number of projected displays.

In particular embodiments, in order to predict a layout score, a neural network receives encoded image information and encoded layout information. Each of these encodings may be represented as a three-dimensional tensor. The neural network may include layers for integrating the two tensors. The trained neural network may include layers that predict the layout score for a potential layout based on the encoded inputs.

Determining the highest score may be performed by any of a number of different approaches. For example, a greedy-search scoring approach may start with a particular projected display (e.g., a projected display corresponding to a user's highest assigned priority) and determine the parameters (e.g., size and location) of the display that maximizes the score of that display. However, this approach may not lead to the globally optimal solution for all the projected displays; for example, the first projected display's highest score may occur when that display takes up most or all of the available projection area, leaving insufficient room for other projected displays. Another scoring option is to test all possible layout combinations, but this approach can be computationally intensive and time-consuming. Another approach may be to use a beam search algorithm, which picks the “k” best sequences so far based on the total score of each screen. Here, k is a fixed hyperparameter; in general, the quality of the results increase as k increases, but the speed of the search algorithm decreases as k increases.

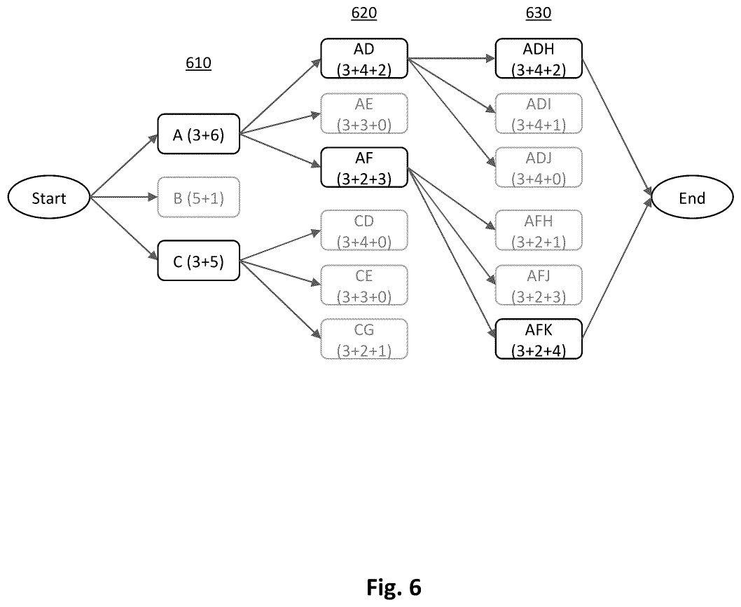

In particular embodiments, a scoring approach may both score a particular projected display, based on the encodings of that's display in the layout, and also may predict a future score for the remaining displays in the layout. FIG. 6 illustrates an example of this scoring approach that adopts a beam search, with k=2. In this example there are three projected displays: display 1, display 2, and display 3. Column 610 in FIG. 6 illustrates placing display 1 in three different layouts (layouts A, B, and C). A neural network scores each layout (which at this point, includes only display 1) and provides a predicted score for the remaining two displays. The layout score and the predicted score are shown in parentheses (e.g., A (3+6) means that layout A has a score of 3 for display 1 and a predicted score of 6 for the remaining two displays). The layout score and the predicted score are added together, and because k=2 in this example, at each iteration the two highest scoring options are selected for the next iteration (here, layouts A and C are selected for the second iteration).

Column 620 illustrates the next iteration. In this iteration, the layout for display 1 is already determined in the previous iteration, and thus its score is fixed (as its layout doesn't change). Display 2 is placed in a variety of different layouts, and the score for each layout is determined. In addition, the iteration predicts the layout score for the third layout, given the layout of the first two displays (e.g., if the first two displays take up all the available space, they may receive a high score, but the third display would have a low predicted score, regardless of which particular possible layout parameters it took). In column 620, the scores shown in parentheses are, from left to right, the scores of the first display, the second display, and the predicted score for the third display. The two highest scoring layouts are selected, and in the next iteration (column 630) the third display is placed in a variety of layouts, and each layout is scored. In this example, the two highest scoring layouts are selected for presentation to the user.

In particular embodiments, a neural network may use two branches (two sets of layers): one for scoring a current projected display under consideration and one for predicting the future score of the remaining displays that have not yet been scored. In particular embodiments, a single branch may perform both scoring and predicted scoring. In a two-branch embodiment, however, the neural network is more interpretable, as a projected display score and a predicted future score for remaining displays are produced separately, and therefore troubleshooting and training can be performed by considering the output of each branch separately.

Returning to the example of FIG. 4, once a score is determined in a particular iteration (i.e., a score is determined for a particular projected display), then step 424 includes post-processing the score. For example, one or more heuristic rules may be used in step 424. For example, if the layout results in a display screen that overlaps with an object (e.g., with a shelf or picture frame), then step 424 may include making that score negative. Post processing results in refined scores 425, and these scores may be used to select the k highest layouts in that iteration for consideration in the next iteration. The stopping condition is shown in step 426, which determines whether the number of screens (i.e., the number of projected layouts requested by the user) is reached. If not, then they layout proposal process iterates; if yes, then the process ends, and the highest scoring layouts are presented to the user in step 428.

While the example of FIGS. 4 and 6 describe an embodiment that uses a deep learning model to score potential layouts, only heuristic rules may be used to score a layout. Heuristic rules do not require model training (i.e., the deep learning model doesn't need to be trained), and such rules are interpretable. However, using only heuristic rules can, in particular embodiments, result in a complex set of rules that increase runtime and may require significant engineering effort to optimize the code of heuristic rules for parallel computing.

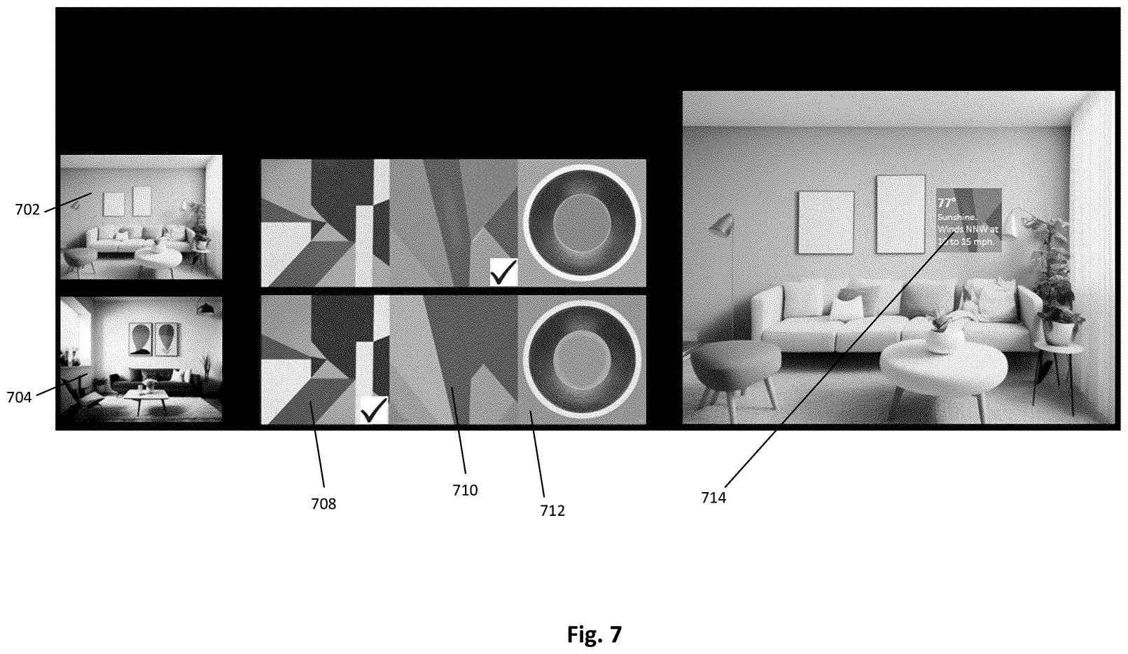

In particular embodiments, projected content may be shown with one or more visual enhancements, and such visual enhancements may be based on visual aspects of the environment, e.g., as captured by the accessed image. For example, a visual enhancement may be a color scheme or background pattern, or both, to project along with the projected content. FIG. 7 illustrates two different environments 702 and 704. Environments 702 and 704 have different geometric features and different color schemes. Based on the geometry and the color scheme of the environment, different corresponding and/or complementary projected color schemes and/or projected geometries may be determined. For example, patterns 708, 710, and 712 each show examples of different patterns that are based on environmental geometries. While the patterns are shown in greyscale, the colors making up the pattern may be based on the colors in the environment (e.g., may be the same color scheme or may be complementary colors, according to various color theories). Projected content may then be customized based on the selected pattern and/or color scheme. For example, projected content 714 in environment 702 is some weather content, and it is projected with a background that contains a geometry and color scheme that are based on the features of environment 702.

FIG. 4 illustrates an example optional contextual customization process 430. Step 432 includes extracting the visual features, for example from the accessed image of the environment. Step 434 includes clustering the visual features to extract the representative visual elements. Corresponding complementary geometries and colors are then selected for the projected content, for example based on a mapping function. Step 436 includes content selection and modification, based on the contextual customization, resulting in customized contents 438. In particular embodiments, customization may occur only for certain kinds of content (e.g., based on user preferences or based on content aspects, such as when the content is text-only, etc.).

Step 130 of the example method of FIG. 1 includes projecting, by a projector, the one or more content items onto at least a portion of the determined region of the surface that is available to project one or more content items onto. In order to project content items without skew, the projector may apply a deskewing transformation (as discussed above) to the projections.

In particular embodiments, some or all of the method of FIG. 1 may repeat periodically. In particular embodiments, the example method of FIG. 1 may be repeated automatically. For example, the method of FIG. 1 may repeat each time a user moves the projector or each time new content is displayed on a display screen. In particular embodiments, the example method of FIG. 1 may be performed on demand, e.g., in response to a user request. In particular embodiments, some or all of the steps of the example method of FIG. 1 may be performed by a computing device in a projector. In particular embodiments, some or all of the steps of the example method of FIG. 1, may be performed (at least in part) by another computing device.

As described throughout this disclosure, while particular embodiments of the projection techniques described herein may result in projecting content in association with a display screen, the techniques described herein are also used to project content when no display screen is present (e.g., to determine the appropriate layout for projecting a variable number of content items onto a surface).

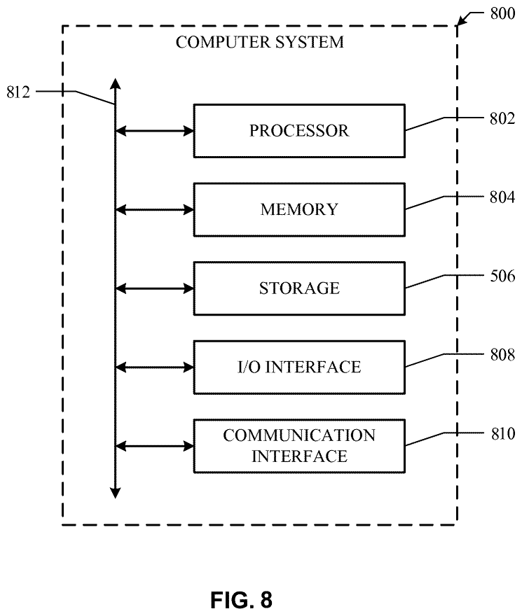

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing an image of a scene comprising a display device and at least a portion of an environment of the display device, the portion of the environment comprising a surface in the vicinity of the display device;
determining, based on the portion of the environment of the display device, a region of the surface that is available to project one or more content items onto; and
projecting, by a projector, the one or more content items onto at least a portion of the determined region of the surface that is available to project one or more content items onto.

2. The method of claim 1, wherein the image comprises a skewed perspective relative to an orientation of the surface, and the method further comprises:
determining, based on one or more geometric features of the scene, a transformation of the image to deskew the perspective; and
transforming the image according to the determined transformation.

3. The method of claim 2, wherein the one or more geometric features comprise at least one of:
a shape of the display device in the image;
a shape of an object in the image; or
a content displayed on the display device in the image.

4. The method of claim 1, wherein determining, based on the portion of the environment of the display device, the region of the surface that is available to project one or more content items onto comprises:
detecting, based on the image, an exclusion area of the surface comprising one or more areas of the surface that are obscured by one or more objects, textures, or colors; and
determining a usable area of the surface in the vicinity of the display device, the usable area comprising an area of the surface in the vicinity of the display device that does not include the exclusion area.

5. The method of claim 4, further comprising dividing the usable area of the surface into a number of potential projection areas, wherein the number of potential projection areas equals a number of the one or more content items.

6. The method of claim 5, wherein the potential projection areas each comprise a rectangular region.

7. The method of claim 1, further comprising determining, based on the determined region of the surface that is available to project one or more content items onto, a layout for each of the one or more content items.

8. The method of claim 7, wherein the layout comprises a size and a position of each content item.

9. The method of claim 7, further comprising determining the layout based on a layout score provided by a trained neural network.

10. The method of claim 9, further comprising:
for each of a plurality of potential layouts, encoding features extracted from the image and features extracted from the potential layout;
for each of the plurality of potential layouts, determining, by the trained neural network, a proposed layout score based on the extracted features from the image and the extracted features of the proposed layout; and
selecting the layout with the highest proposed layout score.

11. The method of claim 10, further comprising:
determining a number of the one or more content items;
assigning each content item a number n;
executing a number n of scoring iterations equal to the number of content items, wherein the nth scoring iteration comprises:
determining a layout score for each of a plurality of potential layouts of the nth content item;
when n is less than the number of content items then predicting, for each of the plurality of potential layouts, a future layout score for the content items associated with a number greater than n;
determining a total score for each potential layout of the iteration based on (1) the layout score of the potential layout, (2) the predicted future layout score for the potential layout, and (3) a previous layout score determined for the n−1 content items in n−1 previous iterations; and
when n is less than the number of content items, then selecting the k highest scoring potential layouts for consideration in the next iteration.

12. The method of claim 11, wherein the trained neural network comprises two branches, a first branch that determines the layout score of the potential layout of the nth content item and a second branch that predicts the future layout score.

13. The method of claim 11, further comprising when n is equal to the number of content items, then selecting the k highest scoring layouts for presentation to a user.

14. The method of claim 1, further comprising:
determining, based on the image of the scene, one or more visual attributes comprising one or more of a color scheme of the scene or a geometric pattern of the scene; and
customizing a visual parameter of at least one of the or more content items based on the determined one or more visual attributes.

15. The method of claim 1, further comprising determining the one or more content items to project by the projector based on at least one of (1) a content displayed on the display device or (2) one or more user preferences.

16. The method of claim 1, further comprising determining a number of the one or more content items to project by the projector based on at least one of (1) a content displayed on the display device or (2) one or more user preferences.

17. One or more non-transitory computer readable storage media storing instructions and coupled to one or more processors that are operable to execute the instructions to:
access an image of a scene comprising a display device and at least a portion of an environment of the display device, the portion of the environment comprising a surface in the vicinity of the display device;
determine, based on the portion of the environment of the display device, a region of the surface that is available to project one or more content items onto; and
cause a projector to project the one or more content items onto at least a portion of the determined region of the surface that is available to project one or more content items onto.

18. The media of claim 17, further comprising one or more processors that are operable to execute the instructions to determine, based on the determined region of the surface that is available to project one or more content items onto, a layout for each of the one or more content items.

19. An apparatus comprising:
a projector; and
one or more non-transitory computer readable storage media storing instructions; and one or more processors coupled to the non-transitory computer readable storage media, the one or more processors operable to execute the instructions to:
access an image of a scene comprising a display device and at least a portion of an environment of the display device, the portion of the environment comprising a surface in the vicinity of the display device;
determine, based on the portion of the environment of the display device, a region of the surface that is available to project one or more content items onto; and
cause the projector to project the one or more content items onto at least a portion of the determined region of the surface that is available to project one or more content items onto.

20. The apparatus of claim 19, further comprising one or more processors that are operable to execute the instructions to determine, based on the determined region of the surface that is available to project one or more content items onto, a layout for each of the one or more content items.
